(19) United States
(12) Patent Application Publication
(10) Pub. No.: US 2007/0175443 A1
(43) Pub. Date: Aug. 2, 2007

(54) Method for controlling the quantity of fuel and/or air to an internal combustion engine on a cylinder-by-cylinder basis

(76) Inventor: Matthias Schueler, Steinheim (DE)

Correspondence Address: KENYON & KENYON LLP, ONE BROADWAY, NEW YORK, NY, 10004, US

(21) Appl. No.: 11/634,575

(22) Filed: Dec. 6, 2006

(30) Foreign Application Priority Data
Dec. 5, 2005 (DE) 10 2005 057 975.2

(51) Int. Cl. F02D 41/00

(52) U.S. Cl. 123/402

(57) ABSTRACT

A method for controlling the quantity of fuel and/or air to an internal combustion engine on a cylinder-by-cylinder basis is characterized in that a signal that is influenced by combustion or pertains to a quantity that influences the combustion and contains items of information from all cylinders, mutually offset in time, is analyzed by ascertaining vibration components in the frequency range caused by cylinder-specific differences and regulating these components separately for selected frequencies, and in that an amplitude regulator that determines the amplitude of a correction intervention measure and a phase regulator that determines the allocation of an intervention pattern with respect to the cylinders are provided for each frequency to be compensated.

### FIELD OF THE INVENTION

The present invention relates to a method for controlling the quantity of fuel and/or air to an internal combustion engine on a cylinder-by-cylinder basis.

### BACKGROUND INFORMATION

In internal combustion engines, in particular self-igniting internal combustion engines, the fuel injection quantity is controlled based on rotational speed on a cylinder-by-cylinder basis. Through this method, also known as quantity compensation regulation, injection quantity errors resulting in differences in torque and thus uneven rotational speeds are compensated. However, errors in air quantity resulting in lambda differences between individual cylinders for the same injection quantity cannot be detected and compensated by this method. Such errors in air quantity may, however, result in very large deviations in the exhaust-gas compositions.

There are lambda-regulating systems for gasoline engines on a cylinder-by-cylinder basis but they are used only with nonsupercharged engines. These methods are based on an analysis in the time range with the help of an observer structure. One such method is described in European Published Patent Application No. 1 426 594, for example.

German Published Patent Application No. 100 62 895 describes a method for individual lambda regulation in which a control deviation and a regulator are assigned to each cylinder of the internal combustion engine, each regulator specifying a cylinder-specific triggering signal based on the assigned control deviation. Cylinder-specific actual values are thus ascertained, based on a signal of a sensor situated in the exhaust system and compared with a setpoint value. Based on the comparison, triggering signals for controlling the quantity of fuel and/or air on a cylinder-by-cylinder basis are specified. This method is based essentially on a frequency analysis similar to the aforementioned quantity compensation regulation in diesel engines. A prerequisite for stable functioning of both of the methods mentioned above is a fixed phase relationship between the injection quantity of the cylinders and the measured lambda value. Both signals represent all cylinders. The injection quantity is allocated to each of the cylinders whereas the lambda value represents a continuous signal and is measured in a portion of the exhaust system through which exhaust gas of all cylinders to be analyzed flows. In the observer model mentioned above, an altered phase relationship may be compensated, e.g., by an altered dead time or by adjusting the allocation of the sampling values to the cylinders.

The phase relationship may also be determined as a characteristics map e.g. via rotational speed-load. It is characteristic, however, that the phase relationship is determined in the calibration phase and the correlation is defined. The methods described above, however, fail to take into account the fact that the phase relationship of the analyzed signals also depends on other parameters. For example, changes in exhaust-gas recirculation rate, pressures and temperatures of the internal combustion engine and in particular the operating parameters of an exhaust turbocharger such as its rotational speed, scoop position and the like have a definite influence on the phase relationship in the signal to be analyzed, e.g., a lambda signal. It is problematical that most of these influences cannot be modeled with sufficient accuracy to minimize the risk of instability of the control circuit, so the previously known cylinder-specific lambda regulating methods are also limited to relatively few operating ranges.

### SUMMARY OF THE INVENTION

An object of the present invention is to improve upon a method for controlling the quantity of fuel and/or air to an internal combustion engine on a cylinder-by-cylinder basis to the extent that all possible influences on the phase relationship are taken into account and compensated, thus permitting stable control of the quantity of fuel and/or air to an internal combustion engine on a cylinder-by-cylinder basis, i.e., a lambda equalization on a cylinder-by-cylinder basis.

The basic idea of the present invention is to ascertain vibration components in the frequency range caused by differences between individual cylinders and to compensate them separately for selected frequencies, to which end the following are provided per frequency to be compensated: an amplitude regulator that determines the amplitude of a correction intervention and a phase regulator that determines the allocation of an intervention pattern with regard to the cylinders.

### BRIEF DESCRIPTION OF THE DRAWINGS

FIG. 1, schematically shows an essentially known internal combustion engine in which the method according to the present invention is used.

FIG. 2 schematically shows the method according to the present invention on the basis of the camshaft frequency.

FIG. 3 schematically shows the calculation of the weighting factors for the intervention patterns.

### DETAILED DESCRIPTION

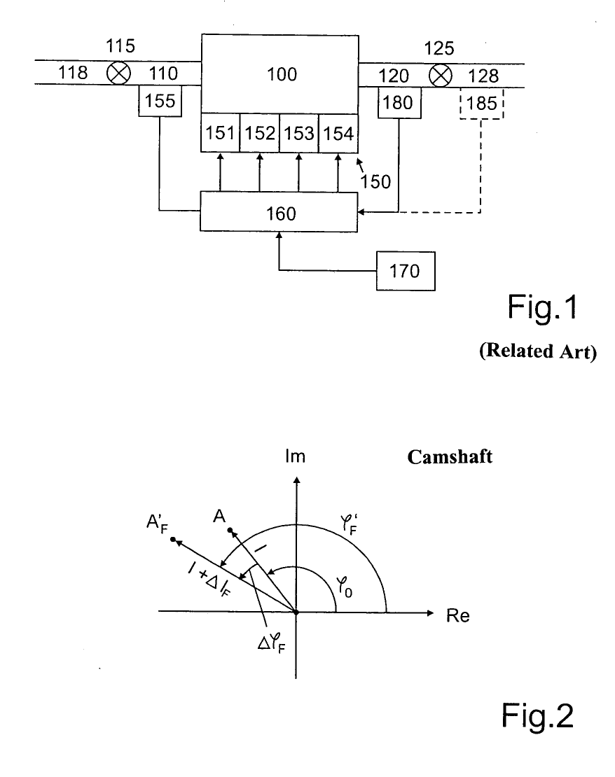

FIG. 1 shows an internal combustion engine 100. Air is supplied to the engine through fresh air line 118, compressor 115 and intake line 110. The exhaust gases from the internal combustion engine enter through exhaust-gas line 120 and turbine 125 into exhaust pipe 128. Turbine 125 drives compressor 115 via a shaft (not shown).

A quantity-determining actuating device 150 is assigned to the internal combustion engine. Fuel is supplied to the internal combustion engine via this actuating device. In the process, an individual fuel quantity may be allotted to each cylinder. This is depicted in FIG. 1 by the fact that a quantity-determining actuating element 151 through 154 is assigned to each cylinder. A control unit 160 applies triggering signals to the individual actuating elements 151 through 154. Actuating elements 151 through 154 are, for example, solenoid valves or piezoelectric actuators, which control the fuel metering in the particular cylinder. It may be provided in this context that per cylinder one injector is provided as well as a distributor pump or another element determining the injected fuel quantity, which alternately meters fuel into the cylinders. Control unit 160 also acts upon another final controlling element 155 that influences the amount of fresh air supplied to internal combustion engine 100. In a simplified specific embodiment, this final controlling element 155 may also be omitted. In addition, control unit 160 processes the output signals of various sensors 170 which for example characterize the ambient conditions, e.g., temperature and pressure values as well as the driver input.

In addition, control unit 170 processes signals from sensors 180 that characterize the exhaust-gas composition or the pressure and/or temperature in the exhaust gas. These sensors 180 are preferably situated between the internal combustion engine and turbine 125. Alternatively or additionally, a sensor 185 may also be situated downstream from the turbine in the exhaust-gas line. Sensors 150 and/or 185 preferably detect a signal characterizing the oxygen concentration in the exhaust gas. Alternatively and/or additionally, it may also be provided for the pressure in the exhaust-gas line to be analyzed upstream or downstream from turbine 125.

The system functions as follows. The fresh air is compressed by compressor 115 and enters internal combustion engine 100 via intake line 110. Quantity-determining actuating device 150 meters fuel into internal combustion engine 100. A cylinder-specific fuel quantity is supplied to each cylinder as a function of the triggering signal of control unit 160. Via the exhaust-gas line, the exhaust gases enter turbine 125, drive the turbine and then reach the environment via exhaust-gas line 128. Turbine 125 drives compressor 115 via a shaft (not shown).

Based on the various input signals, the driver input in particular, control unit 160 calculates the triggering signals for acting upon actuating elements 151 through 154. A preferred specific embodiment additionally final controlling element 155, which controls the air supply to the internal combustion engine. This may be, for example, an exhaust-gas recirculation system that determines the quantity of recirculated exhaust gas. In a particularly preferred specific embodiment the quantity of air supplied to the individual cylinder is influenced. This may be implemented by valve control of the inlet and outlet valves, for example.

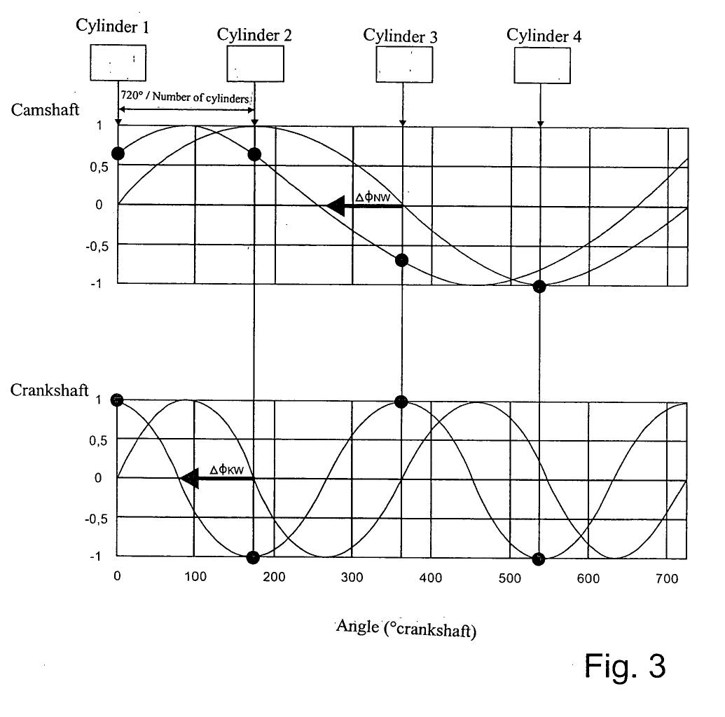

Ascertaining the triggering signals for actuating elements 151 through 155 will be explained now in greater detail in conjunction with FIGS. 2 and 3.

The lambda signal ascertained by sensor 180 is analyzed in the frequency range. The relevant frequencies are the camshaft frequency (NW) and its harmonics up to half the ignition frequency, e.g., for a four-cylinder engine NW, 2NW=KW (crankshaft frequency). In contrast with generally known methods, emerging e.g., from DE 100 62 895 A1, the method described below determines, in addition to the amplitude of these frequencies, also their phase. These may be ascertained using a fast Fourier transform, for example. Alternatively, the signal may also be bandpass filtered. For this purpose, the phase value is easily ascertained, e.g., from the passages through zero. Since there need not be any fixed correlation between the phase changes at the various frequencies, a separate regulator for coordinating internal combustion engine 100 is used for each frequency, as explained in greater detail below.

FIG. 2 shows as an example how a cylinder-specific detuning at a certain frequency F may be depicted as a point A_{F} in the complex plane, length l_{F} representing the complex amplitude of the vibration and angle φ_{F} representing the phase offset between injection of one cylinder and the effect on the output signal detected by sensor 180. The basic idea of the present invention is to create a regulator divided into a phase regulator and an amplitude regulator for each frequency.

The task of the phase regulator is to determine the correct intervention pattern, i.e., the distribution of the intervention of the amplitude regulator to the individual cylinders. Since only differences between individual cylinders are to be compensated, the sum of the interventions must always equal zero for each frequency.

FIG. 3 shows the allocation for camshaft frequency NW and crankshaft frequency KW in a four-cylinder engine as an example of the method according to the present invention. A periodic mean-free function, e.g., a sine function, is used as the basic function, containing one period for the NW frequency and more periods accordingly for its harmonics.

Injection pattern G is obtained for each frequency F from the basic function on the basis of the angle assignment for the individual cylinders, the separation of the cylinders with respect to one another being fixed 2π/number of cylinders, but the absolute starting angle of the assignment being arbitrary, e.g., 0 for cylinder 1. Weighting factors of the injection patterns are ascertained as follows:

$${g}_{NW} = [ {g}_{NW , Cy 11} , {g}_{NW , Cy 12} , {g}_{NW , Cy 13} , {g}_{NW , Cy 14} ]$$

$${g}_{NW} = [ {g}_{KW , Cy 11} , {g}_{KW , Cy 12} , {g}_{KW , Cy 13} , {g}_{KW , Cy 14} ]$$

$$or$$

$${g}_{NW} = [ sin ( Δ {Φ}_{NW} ) ; sin ( \frac{π}{2} + {ΔΦ}_{NW} ) ; sin ( π + {Φ}_{NW} ) ; sin ( \frac{3 \cdot π}{2} + {ΔΦ}_{NW} ) ] ;$$

$${g}_{KW} = [ sin ( Δ {Φ}_{NW} ) ; sin ( 2 \cdot \frac{π}{2} + {ΔΦ}_{KW} ) ; sin ( 2 \cdot π + {Φ}_{KW} ) ; sin ( 2 \cdot \frac{3 \cdot π}{2} + {ΔΦ}_{KW} ) ] ;$$

where ΔΦ is an angle offset for the shift in the injection pattern as determined by the phase regulator. Based on a cylinder-specific initial detuning of the signal to be analyzed at a frequency F having amplitude 1 (FIG. 2, point A) and an initial setting of intervention pattern g_{F}, the amplitude regulator attempts to compensate the vibration via a quantity intervention Δme_{F}. If the intervention pattern is not correct, however, i.e., the phase regulator is not tuned in a stable manner, a change results in the complex plane to A_{F}′. Both regulators may be active at the same time for this purpose. This results in a phase change Δφ_{F} and an amplitude change Δl_{F}. A positive Δφ_{F} means a larger phase offset between the intervention quantity and the output quantity.

The object of the phase regulator is to prevent phase changes Δφ_{F} between the input signal and output signal. The absolute value of phase φ_{F} is not important, however. If φ_{F} changes due to an intervention into the injection quantities to φ_{F}′, the phase regulator then attempts to keep the phase constant at φ_{F}′. For this purpose, the phase regulator adjusts the intervention pattern through intervention into phase offset Δφ_{F} in such a way that the previous phase change is counteracted. If an intervention having a certain intervention pattern into the injection quantity does not result in a phase shift, i.e., Δφ_{F}=0, but only results in an amplitude change, then intervention pattern g_{F} into the different cylinders corresponds to the ratio of the actual detuning of the cylinders with respect to one another. The amplitude regulator may then coordinate the cylinders via the magnitude of intervention Δme_{F}, i.e., it may then compensate the vibration. Point A_{F}′ then migrates in the complex plane directly to the origin, i.e., the cylinders are coordinated. Even if the phase cannot be kept entirely constant, the amplitude regulator ensures a reduction in complex amplitude.

The intervention into the injection quantity of the cylinder Δme_{Cyl.i} is thus obtained from
Δme_{Cyl.i}=Δme_{NW}·g_{NW,Cyl.i}+Δme_{KW}·g_{KW,Cyl.i}.

For example, a PI regulator may be used for this regulating operation. To stabilize the regulating operation at the origin, the intervention quantity of the amplitude regulator may be selected as a function of the distance from the zero point or, in the case of a small amplitude, i.e., when the value falls below a shutdown threshold, the amplitude regulator, like the phase regulator, may be shut down entirely. It is reactivated on exceeding an activation threshold. By superimposing the regulators for the different frequencies, the internal combustion engine is coordinated on the whole. This regulator is insensitive to further phase shifts, e.g., due to signal filtering.

It should be emphasized that the method described above may be used in addition to a lambda compensation regulating method with all systems in which a joint output signal is analyzed, which has influences from various input quantities that are separated by a phase offset. The above method is especially suitable for regulating non-phase-stable systems. Thus, for example, the regulator may also be used for regulating air quantity if air interventions are possible on a cylinder-by-cylinder basis. The regulating method described above also has the great advantage that the regulator may be used as a self-learning regulator for phase-stable systems for reducing the need for calibration, e.g., for regulating rotational speed as an alternative to known quantity compensation regulating methods.

What is claimed is:

1. A method for controlling a quantity of fuel and/or air to an internal combustion engine on a cylinder-by-cylinder basis, comprising:
analyzing a signal influenced by the combustion or pertaining to a quantity having influence on combustion and containing items of information from all cylinders, mutually offset in time, by ascertaining vibration components in the frequency range caused by cylinder-specific differences;
regulating the vibration components separately for selected frequencies; and
providing an amplitude regulator that determines the amplitude of a correction intervention and a phase regulator that determines the allocation of an intervention pattern with respect to the cylinders are provided for each frequency to be compensated.

2. The method as recited in claim 1, wherein the frequency of a camshaft signal and its multiples up to and including half the ignition frequency are analyzed.

3. The method as recited in claim 1, wherein an intervention into individual cylinder-specific actuating elements is performed, based on superimposing the control interventions ascertained for individual frequencies, in such a way that the control interventions at selected frequencies are calculated from the frequency-specific intervention amplitude ascertained by the amplitude regulator and the value derived for this cylinder from the frequency-specific intervention pattern.

4. The method as recited in claim 1, wherein the intervention pattern for a certain analysis frequency is a mean-free pattern and has a periodicity corresponding to this frequency.

5. The method as recited in claim 4, wherein the intervention pattern supplies a cylinder-specific value and is calculated on the basis of a sine as the basic function, a phase shift of the sine being implementable by an additive intervention by the phase regulator into the angle argument.

6. The method as recited in claim 1, wherein the phase regulator can induce a continuous shift in the intervention pattern between the cylinders through an additive intervention into the angle argument.

7. The method as recited in claim 1, wherein the phase regulator of a frequency keeps the intervention pattern constant when the ascertained cylinder-specific vibration at this frequency changes on account of the regulating intervention only in amplitude but not in phase.

8. The method as recited in claim 1, wherein with a change in phase, the phase regulator influences the angle argument of the periodic function in such a way that the intervention pattern into the cylinders is shifted so that this phase change is counteracted.

9. The method as recited in claim 1, wherein the amplitude regulator for a certain frequency compensates the vibration through intervention into the corresponding controlling amplitude.

10. The method as recited in claim 1, wherein when the shutdown threshold for the amplitude of a frequency is undershot, the regulating process by amplitude and phase regulators is stopped for this frequency and is not restarted until an activation threshold is exceeded.

11. The method as recited in claim 1, wherein the phase and amplitude regulators are active at the same time.

12. The method as recited in claim 1, wherein the phase and amplitude of the selected signal frequencies are ascertained by a Fourier transform or a fast Fourier transform.

13. The method as recited in claim 1, wherein the phase and the amplitude of the selected signal frequencies are ascertained by bandpass filtering.

14. The method as recited in claim 1, wherein the phase and/or amplitude of the individual frequencies are kept constant by a PI regulator.

15. The method as recited in claim 1, wherein the rotational speed signal is used as the input signal and the cylinder-specific injection quantity is used as the intervention quantity.

16. The method as recited in claim 1, wherein the lambda value, the pressure in the intake tract or the pressure in the exhaust system is used as the input signal, and the cylinder-specific injection quantity or cylinder-specific air controller is used as the intervention quantity.
